(19) United States
(12) Patent Application Publication
(10) Pub. No.: US 2011/0036097 A1
(43) Pub. Date: Feb. 17, 2011

(54) SYSTEM FOR PRODUCING POWER, IN PARTICULAR ELECTRICAL POWER, WITH A GAS TURBINE AND A ROTARY REGENERATIVE HEAT EXCHANGER

(76) Inventor: Etienne Lebas, Seyssuel (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/599,975

(22) PCT Filed: May 14, 2008
(86) PCT No.: PCT/FR2008/000677

§ 371 Date: Oct. 25, 2010

(30) Foreign Application Priority Data
May 15, 2007 (FR) 0703552

(51) Int. Cl. F02C 6/00

(52) U.S. Cl. 60/801

(57) ABSTRACT

The present invention relates to a system for producing power, notably electrical power, comprising a gas turbine (10) with at least one compressor (12; 12a, 12b) having at least one compression stage, at least one expansion turbine (16), a heat exchanger (14) between said compressor and said expansion turbine, and a hot gas source (48, 72).

According to the invention, the exchanger is a rotary regenerative exchanger (14) through which the hot gases and compressed gases from said compressor pass.

### FIELD OF THE INVENTION

The present invention relates to a system for producing power, notably electrical power, comprising a gas turbine with a compressor, an expansion turbine and a device allowing to heat the compressed gases leaving the compressor so as to send them to the expansion turbine.

Electrical power production generally results from a generator that is coupled to the expansion turbine of this gas turbine.

The hot gas source used for this power production system can come from a high-temperature heat recovery in an industrial process, such as a furnace, or from the combustion of a solid fuel, such as biomass, in a burner type combustion chamber device.

### BACKGROUND OF THE INVENTION

Such a system, already known notably from document WO-02/055,855, uses as the compressed gas heating device a heat exchanger through which pass, on the one hand, the hot fumes from a burner using a fuel on a biomass basis and, on the other hand, the compressed gases leaving the compressor.

The calories carried by the fumes are thus transmitted to the compressed gases in such a way that these gases reach the expansion turbine with sufficient temperature and pressure to rotate it. Under the impulse of this rotation, this turbine drives a current generator to which it is coupled.

Although this type of system gives satisfactory results, it however involves some not insignificant drawbacks.

In fact, the heat exchanger used does not allow to transfer a sufficient amount of calories in order to substantially increase the temperature of the compressed gases and, as it is well known, the higher the temperature of the gases sent to the expansion turbine, the higher the electrical efficiency. The electrical efficiency obtained by this system is therefore relatively modest, below 20%.

Furthermore, the technology of the exchangers conventionally used in such a system, such as tube exchangers, is not quite appropriate for this application. The tubes must be made of special steels to withstand high temperatures, which makes this equipment very expensive. Besides, the maximum temperature reached by the compressed gases at the exchanger outlet remains limited to 750° C., which does not allow to obtain a good electrical efficiency for the plant.

The present invention aims to overcome the aforementioned drawbacks by means of an electrical power production system allowing to obtain a high energy efficiency using a high-performance heat exchanger that can increase the compressed gas heating temperatures.

### SUMMARY OF THE INVENTION

The present invention thus relates to a system for producing power, notably electrical power, comprising a gas turbine with at least one compressor having at least one compression stage, at least one expansion turbine, a heat exchanger between said compressor and said expansion turbine, and a hot gas source, characterized in that the exchanger is a rotary regenerative exchanger through which the hot gases from said source and compressed gases from said compressor pass.

The rotary regenerative exchanger can comprise a disc with a multiplicity of radial sectors through which said hot gases and said compressed gases alternately pass.

The regenerative exchanger can comprise compressed gas and hot gas inlet boxes and compressed gas and hot gas outlet boxes.

The electrical power production system can comprise a hot fluid generator through which the hot gases leaving the exchanger pass.

The electrical power production system can comprise a hot fluid generator arranged between the compressor and the exchanger.

The compressor can comprise at least two compression stages and a hot fluid generator can be arranged between the two stages.

Preferably, the hot gas source can comprise a combustion chamber.

The combustion chamber can comprise at least one inlet for air coming from the expansion turbine.

The combustion chamber can comprise at least one fresh air inlet.

The fresh air inlet can be connected by a line to the expansion turbine and this line can run through an intercooler. The combustion chamber can comprise an inlet for a solid fuel.

Advantageously, the fuel can comprise biomass.

The hot gas source can come from a high-temperature heat recovery in an industrial process.

Preferably, the heat exchanger is a sequential type rotary regenerative exchanger.

### BRIEF DESCRIPTION OF THE FIGURES

Other features and advantages of the invention will be clear from reading the description hereafter, given by way of non limitative example, with reference to the accompanying figures wherein:

FIG. 1 is a diagram illustrating, the electrical power production system according to the invention,

FIG. 2 is a perspective detail view of the heat exchanger used in the system according to the invention,

FIG. 3 is a diagram of a first variant of the system of FIG. 1,

FIG. 4 is a diagram illustrating another variant of the system of FIG. 3, and

FIG. 5 is a diagram illustrating another variant of the system of FIG. 4.

### DETAILED DESCRIPTION

In FIG. 1, the power production system comprises a gas turbine 10 with a gas compressor 12 having at least one compression stage, a regenerative type heat exchanger 14 that is described in detail in the description below, an expansion turbine 16 connected by a shaft 18 to the compressor, and an electrical power production means 20 controlled by the expansion turbine. In the example of FIG. 1, this electrical power production means comprises an electrical generator 22 connected by a shaft 24 to expansion turbine 16.

The compressor comprises an inlet 26 for a gas such as exterior air here, connected to an air inlet line 28 and a compressed air outlet 30 connected by a line 32 to a compressed air inlet 34 of exchanger 14. Compressed air outlet 36 of this exchanger is connected by a line 38 to inlet 40 of expansion turbine 16. Outlet 42 of this turbine is connected to a line 44 allowing the hot expanded gases to be discharged to any suitable means.

Exchanger 14 comprises a hot gas inlet 46, like one from a high-temperature heat recovery in an industrial process or from the combustion of a solid fuel, which is connected by a line 48 to the hot gas source. After flowing through this exchanger, the hot gases are discharged through an outlet 50 and a line 52 to any discharge and treatment means such as a chimney (not shown).

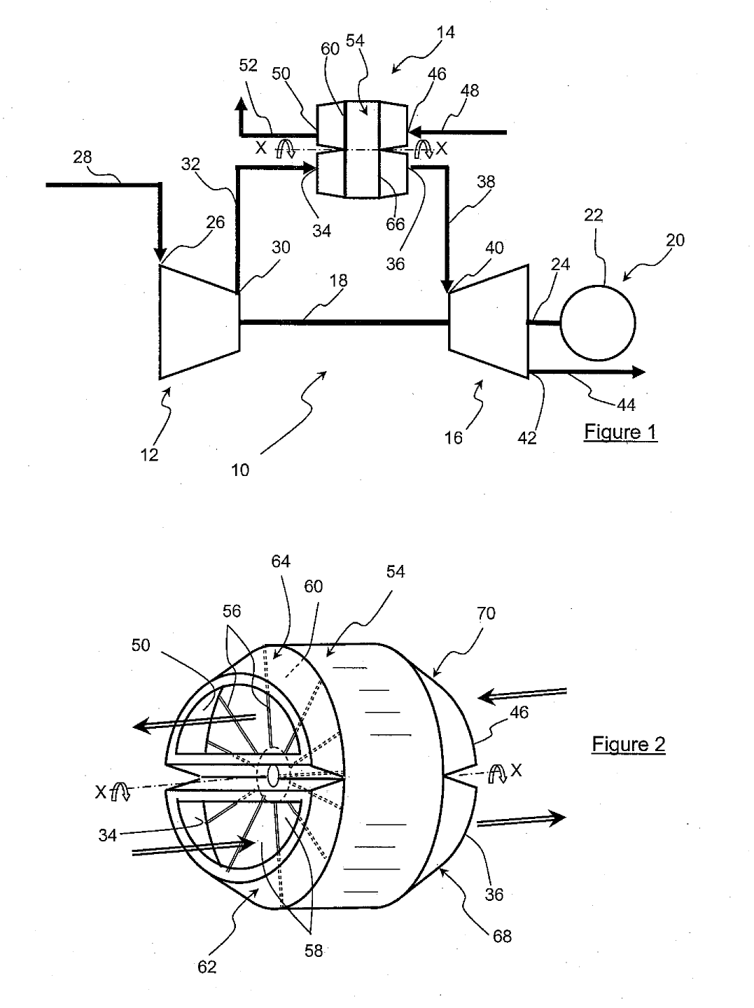

FIG. 2 shows an embodiment of the regenerative heat exchanger based on the principle of Lugjström type rotary exchangers, as described by way of example in document U.S. Pat. No. 1,522,825.

This exchanger comprises a rotary heat exchange disc 54 driven in rotation about its axis XX by any known means, such as an electric motor (not shown), in a continuous or sequential motion. This disc is divided by radial partitions 56 into a multiplicity of radial exchange sectors 58, here twelve 30° sectors, through which compressed air from compressor 12 and the hot gases from hot gas line 48 pass alternately. Each sector comprises a material allowing storage and destorage of the calories, such as a mullite or cordierite type ceramic.

As illustrated in FIG. 2, each face of the disc is in connection with fixed fluid inlet and outlet boxes. Thus, face 60, on the left in FIG. 1, is in connection with a compressed air inlet box 62 carrying inlet 34 connected to line 32 and with a hot gas outlet box 64 carrying hot gas outlet 50 connected to line 52. The other face 66 comprises a compressed air outlet box 68 with outlet 36 connected to line 38 and a hot gas inlet box 70 comprising hot gas inlet 46 connected to line 48.

Advantageously, each box has a semicircular shape and two boxes are arranged on each face of the disc, each one opposite the other, so that these two boxes cover the entire considered face of the disc.

Preferably, there are devices providing sealing between each face and the boxes, quasi perfectly between the various parts. These sealing devices can notably be those described in U.S. Pat. No. 5,259,444.

By way of example, a sequential rotation of disc 54 of the order of a quarter turn is provided. Thus, the hot gases flow through sectors 58 of an upper half of the disc (considering FIG. 2) between inlet 46 and outlet 50 while collecting the calories contained in these gases, these sectors thus becoming high-temperature sectors, while the compressed air from the compressor flows through sectors 58 of the other half, between inlet 34 and outlet 36, this compressed air being thus heated to a high temperature by means of the calories contained in these various sectors 66. This position is maintained for a sufficient time required for, on the one hand, the fumes to cool down while transmitting a maximum amount of calories to the constituents of each sector of the upper half of the disc and, on the other hand, for the calories contained in the sectors of the lower half of the disc to be transmitted to the compressed air so as to heat it to a high temperature.

After this time, the disc is driven into a quarter turn rotation about its axis XX under the impulse of the electric motor and it remains in this position for a sufficient and necessary time, as mentioned above. This quarter turn rotating motion is then repeated throughout operation of the turbine.

During operation of the system illustrated in FIG. 1, exterior air, preferably at ambient temperature and pressure, is allowed through inlet 26 of compressor 12 in order to be compressed. This compressed air is then sent through line 32 to inlet 34 of the rotary regenerative exchanger in order to be heated as mentioned above. It leaves the exchanger with a high temperature (of the order of 900° C.) and it is carried by line 38 to inlet 40 of expansion turbine 16. This very hot compressed air produces a rotation of this turbine, which in turns drives into rotation compressor 12 through shaft 18 and generator 24 through shaft 26. The expanded air leaving expansion turbine 16, substantially at atmospheric pressure, is sent through line 44 to any suitable means.

The hot gases that are sent through line 48 to exchanger 14 flow through this exchanger between inlet 46 and outlet 50 while yielding a very large part of their heat to part of sectors 58 of disc 54. The cooled gases leave exchanger 14 and are sent through line 52 to the chimney.

This system allows to obtain, for heat exchanger 14, a very high thermal efficiency (above 97%), which allows to heat to a very high temperature (above 900° C.) the fluid to be sent to the expansion turbine, thus allowing to obtain an electrical efficiency above 30% for the generation system.

The variant of FIG. 3 differs from the system illustrated in FIG. 1, on the one hand, in the configuration of the source of hot gases from a combustion and, on the other hand, in a device allowing hot water to be produced.

Thus, this source is advantageously a burner type combustion chamber 72 comprising an oxidizer intake 74 and a fuel intake 76. In the configuration of FIG. 3, the expanded air from expansion turbine 16 is used as an oxidizer by the burner via line 44, but any other configuration for feeding oxidizer to this burner can be used, such as an exterior air supply. Advantageously, fuel intake 76 is connected to a delivery line 78 supplying a solid fuel such as biomass, but any other type of fuel can be used, such as biogas. Thus, this oxidizer mixes with the biomass fed into inlet 76 of burner 72 so as to generate combustion under the effect of any means such as a flame. This burner also comprises a discharge end 82 for the hot gases (or fumes) resulting from the combustion, which is connected to line 48.

This system also comprises a generator 84 of hot fluid such as hot water, through which the fumes leaving exchanger 14 pass, and which allows to use part of the heat generated by burner 72 to produce this hot water. Generally, this generator consists of a radiator through which flow the fumes leaving the exchanger and circulating in line 52, as well as water that is supplied through a line 86 in liquid form and flows out through a line 88 in heated form. In this case, the gas turbine is referred to as cogeneration turbine (electricity+heat).

Operation of the system shown in this figure is the same as described in connection with FIG. 1, with the additional stages of hot water production by generator 84 and hot fumes production by the burner.

Thus, this system allows to achieve air compression by compressor 12, heating of this compressed air by passage through part of the radial sectors of disc 54 of exchanger 14 and expansion of the hot compressed air in expansion turbine 16 by generating a rotation of this turbine and, consequently, a rotation of generator 22 to produce electricity.

The expanded air leaving the turbine is then sent to burner 72 where combustion takes place with the biomass type fuel supplied. The fumes resulting from this combustion flow through the other part of the radial sectors of exchanger 14 while cooling down, then through hot water generator 84 where they heat the water contained therein.

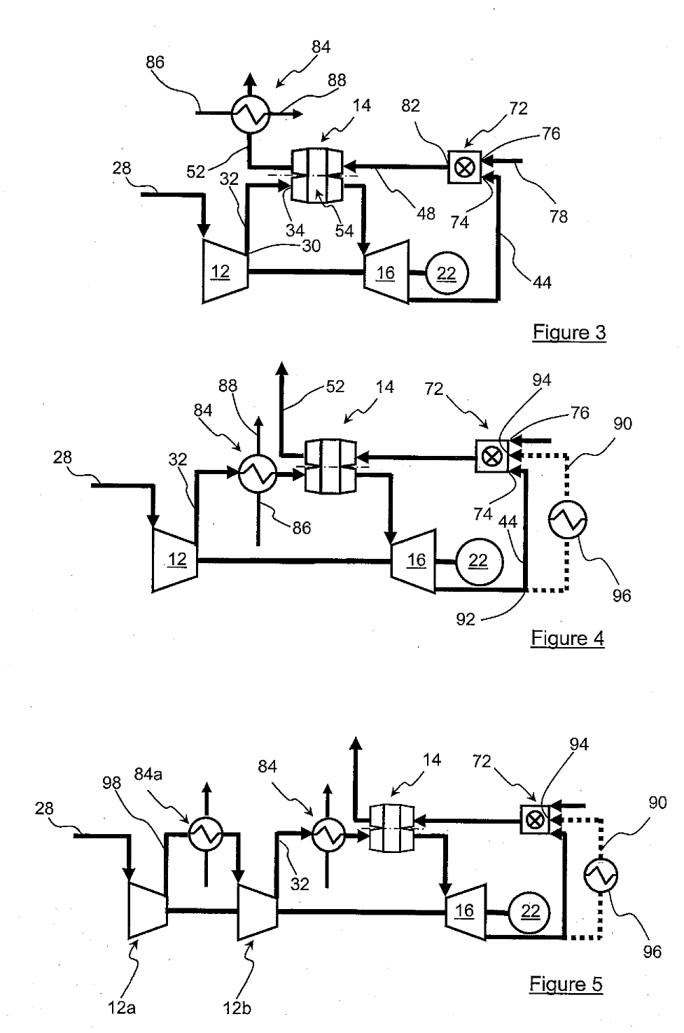

The variant of FIG. 4 differs from that of FIG. 3 in the cooling of the compressed air leaving compressor 12 while allowing to heat a fluid such as water, not from the heat of the fumes but from this compressed air, and cooling of part of the expanded air leaving expansion turbine 16.

Thus, generator 84 that was arranged on line 52 in FIG. 3 is arranged, in the case of FIG. 4, on line 32 between outlet 30 of compressor 12 and inlet 34 of exchanger 14.

This allows, on the one hand, to lower the temperature of the compressed air to about 25° C. at the inlet of exchanger 14 and to recover a larger amount of heat from the combustion fumes flowing through this exchanger. On the other hand, the temperature of the compressed air is substantially at a constant level and the calories carried thereby are used to obtain hot water at the generator outlet, whatever the temperature of the fumes that may undergo significant variations.

This variant also makes it possible to cool part of the expanded air coming from expansion turbine 16 and to inject it into the inlet of burner 72 in addition to the expanded air already injected at inlet 74 through line 44. A bypass line 90 connecting a point 92 of line 44 and a fresh air inlet 94 at the level of burner 72 is therefore provided. An intercooler 96 is arranged on this line and it allows to lower the temperature of the expanded air flowing therethrough to the ambient temperature level, through exchange with exterior air for example.

This fresh air injection is more particularly intended for primary air injection into grid type burners that do not withstand high inlet air temperatures.

Operation of the system of FIG. 4 is the same as that of FIG. 3 and is therefore only described hereafter in broad outline.

This system thus allows to achieve air compression by compressor 12, cooling of this air by passage through generator 84 while producing hot water, heating of this compressed air by part of exchanger 14, expansion of the hot compressed air in expansion turbine 16 with rotation of this turbine and of generator 22 to produce electricity. The expanded air leaving the turbine is then sent to burner 72, directly for part of this expanded air and, for the other part, after passage through intercooler 96 in order to be cooled. This expanded air is then used to achieve combustion with the biomass that is fed into the burner. The fumes resulting from this combustion flow through the other part of the exchanger while cooling down, then they are discharged to the chimney.

The variant of FIG. 5 differs from that of FIG. 4 in that the overall efficiency of the system is designed to be increased by decreasing the compression work.

Thus, from FIG. 4, compressor 12 is intended to be replaced by a compressor with two stages 12a and 12b. The inlet of first stage 12a is connected to exterior air inlet line 28, the outlet of second stage 12b is connected through line 32 to exchanger 14 while passing through generator 84 and a line 8 connects the outlet of the first stage to the inlet of the second compression stage. An additional hot fluid generator 84a is arranged on line 98 between the two compression stages and it is used to generate hot water.

The exterior air allowed through line 28 is thus compressed to a first level by first compression stage 12a. At the outlet of this first stage, the hot compressed air circulates in line 98 and flows through additional generator 84a in order to exchange the calories it carries with the water circulating therein by producing hot water. The cooled compressed air leaving the additional generator then passes into second compression stage 12b from which it flows out and circulates in line 32 by flowing through generator 84 prior to entering exchanger 14. The system of FIG. 5 then operates in the same way as described in connection with FIG. 4.

The present invention is not limited to the examples described above and it encompasses any variant or equivalent.

1) A system for producing power, notably electrical power, comprising a gas turbine with at least one compressor having at least one compression stage, at least one expansion turbine, a heat exchanger between said compressor and said expansion turbine, and a hot gas source, characterized in that the exchanger is a rotary regenerative exchanger through which the hot gases from said source and compressed gases from said compressor pass.

2) An electrical power production system as claimed in claim 1, characterized in that rotary regenerative exchanger comprises a disc with a multiplicity of radial sectors through which said hot gases and said compressed gases alternately pass.

3) An electrical power production system as claimed in claim 1, characterized in that rotary regenerative exchanger comprises compressed gas and hot gas inlet boxes and compressed gas and hot gas outlet boxes.

4) An electrical power production system as claimed in claim 1, characterized in that it comprises a hot fluid generator through which the hot gases leaving exchanger pass.

5) An electrical power production system as claimed in claim 1, characterized in that it comprises a hot fluid generator arranged between compressor and exchanger.

6) An electrical power production system as claimed in claim 1, characterized in that the compressor comprises at least two compression stages and in that a hot fluid generator is arranged between the two stages.

7) An electrical power production system as claimed in claim 1, characterized in that the hot gas source comprises a combustion chamber.

8) An electrical power production system as claimed in claim 7, characterized in that combustion chamber comprises at least one air inlet for air coming from expansion turbine.

9) An electrical power production system as claimed in claim 7, characterized in that combustion chamber comprises at least one fresh air inlet.

10) An electrical power production system as claimed in claim 9, characterized in that fresh air inlet is connected by a line to expansion turbine and in that this line runs through an intercooler.

11) An electrical power production system as claimed in claim 1, characterized in that combustion chamber comprises a solid fuel inlet.

12) An electrical power production system as claimed in claim 11, characterized in that the fuel comprises biomass.

13) An electrical power production system as claimed in claim 1, characterized in that the hot gas source comes from a high-temperature heat recovery in an industrial process.

14) An electrical power production system as claimed in claim 1, characterized in that the heat exchanger is a sequential type rotary regenerative exchanger.
